(19) United States
(12) Patent Application Publication
(10) Pub. No.: US 2006/0131845 A1
(43) Pub. Date: Jun. 22, 2006

(54) A MULTI-CHAMBERED AIR BAG FOR A MOTOR VEHICLE

(75) Inventors: Jamel Belwafa, Ann Arbor, MI (US); Karen Balavich, Lake Orion, MI (US); Krishnakanth Aekbote, Farmington Hills, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 10/905,239

(22) Filed: Dec. 22, 2004

(51) Int. Cl. B60R 21/24

(52) U.S. Cl. 280/729

(57) ABSTRACT

A side impact air bag for a motor vehicle. The air bag includes a plurality of chambers. Each chamber is associated with a head, shoulder, thorax, or pelvic region of a seat occupant. A separator is disposed between adjacent chambers. The chambers may be inflated to different pressures and in various sequences.

### BACKGROUND OF THE INVENTION

1. Field of the Invention

The present invention relates to an air bag for a motor vehicle, and more particularly to a multi-chambered side impact air bag that is deployed in response to a vehicle impact event.

2. Background Art

Multi-chambered air bags are known in the vehicle air bag art, such as that disclosed in U.S. Pat. No. 5,586,782. The air bag in the aforementioned patent includes upper and lower chambers. The upper chamber protects the head and neck of a seat occupant while the lower chamber protects the thorax and shoulder regions of the seat occupant.

The applicants of the present invention have discovered that improved occupant protection is achieved by employing an air bag that incorporates localized chambers associated with the head, shoulder, thorax, and/or pelvic regions of a seat occupant. More specifically, the applicants of the present invention have discovered that an air bag with chambers that are more localized than those of previous air bags advantageously permits inflation pressures and chamber inflation sequences to be tailored to provide improved cushioning of a seat occupant during a side impact event.

Before applicants' invention, there was a need for an improved side impact air bag for a motor vehicle. In addition, there was a need for a side impact air bag having localized chambers associated with the head, shoulder, thorax, and/or pelvic regions of a seat occupant. In addition, there was a need for an air bag having localized chambers that could be inflated to different pressures and/or in different sequences. In addition, there was a need for an air bag that provides different levels of support or cushioning for the head, shoulder, thorax, and/or pelvic regions of a seat occupant to improve occupant safety. Problems associated with the prior art as noted above and other problems are addressed by applicants' invention as summarized below.

### SUMMARY OF THE INVENTION

According to one aspect of the present invention, a side impact air bag for a motor vehicle is provided. The side impact air bag has a deflated condition in which the air bag is located within a vehicle seat and an inflated condition in which the air bag is located between a seat occupant and an interior vehicle surface. The air bag has a first chamber, a second chamber, and a first separator. The first chamber has an inlet for receiving an inflation gas from an inflation gas source. The second chamber is disposed adjacent to the first chamber. The first separator is disposed between the first and second chambers. The first separator is adapted to communicate the inflation gas from the first chamber to the second chamber. The first chamber is disposed proximate a shoulder of the seat occupant and the second chamber is disposed proximate a thorax of the seat occupant when the side impact air bag is in the inflated condition. The air bag allows different inflation pressures and chamber inflation sequences to be provided to improve cushioning and protection of the seat occupant.

The first chamber may have a higher pressure than the second chamber within 20 milliseconds after the inflation gas is provided to inflate the side impact air bag.

The first separator may include at least one aperture adapted to communicate the inflation gas from the first chamber to the second chamber. The first separator may be a gas permeable membrane adapted to communicate the inflation gas from the first chamber to the second chamber.

The side impact air bag may include a third chamber and a second separator. The third chamber may be disposed adjacent to the first chamber and proximate a head of the seat occupant when the side impact air bag is in the inflated condition. The second separator may be disposed opposite the first separator and between the first and third chambers. The second separator may be adapted to communicate the inflation gas from the first chamber to the third chamber.

The first chamber may have a higher pressure than the third chamber and the third chamber may have a higher pressure than the second chamber within 20 seconds after the inflation gas is provided to inflate the side impact air bag.

The first separator may restrict the flow of inflation gas from the first chamber to the second chamber more than the second separator restricts the flow of inflation gas from the first chamber to the third chamber.

According to another aspect of the present invention, a side impact air bag for a motor vehicle is provided. The side impact air bag has a deflated condition in which the air bag is located within a vehicle seat and an inflated condition in which the side impact air bag is located between a seat occupant and an interior vehicle surface. The side impact air bag includes first, second, and third chambers and first and second separators. The first chamber has a first inlet for receiving an inflation gas from an inflation gas source. The second chamber is disposed adjacent to the first chamber. The third chamber is disposed adjacent to the second chamber and opposite the first chamber. The third chamber has a second inlet for receiving the inflation gas from the inflation gas source. The first separator is disposed between the first and second chambers. The second separator is disposed between the second and third chambers. The first, second, and third chambers are disposed proximate a shoulder, thorax, and pelvis of the seat occupant when the side impact air bag is in the inflated condition.

The side impact air bag may include a fourth chamber and a third separator. The fourth chamber may be disposed adjacent to the first chamber, opposite the second chamber, and proximate a head of the seat occupant when the side impact air bag is in the inflated condition. The third separator may be disposed between the first and fourth chambers and opposite the first separator.

The first separator may be adapted to communicate the inflation gas from the first chamber to the second chamber. The second separator may be adapted to communicate the inflation gas from the third chamber to the second chamber. The third separator may be adapted to communicate the inflation gas from the first chamber to the fourth chamber.

The third chamber may have a higher pressure than the first chamber and the first chamber may have a higher pressure than the second chamber within 20 seconds after the inflation gas is provided to inflate the side impact air bag. The first chamber may have a higher pressure than the fourth chamber and the third chamber may have a higher pressure than the second chamber within 20 milliseconds after the inflation gas is provided to inflate the side impact air bag.

The third separator may restrict the flow of inflation gas from the first chamber to the fourth chamber more than the second separator restricts the flow of inflation gas from the third chamber to the second chamber. The first and third chambers may be inflated before the second and third chambers to provide improved spacing of the occupant from an interior vehicle surface.

According to another aspect of the present invention, a side impact air bag for a motor vehicle is provided. The side impact air bag has a stored condition in which the side impact air bag is located within a vehicle seat and an inflated condition in which the side impact air bag is located between a seat occupant and an interior surface of a vehicle door. The side impact air bag includes a first chamber, a second chamber, and a separator. The first chamber has an inlet for receiving an inflation gas from an inflation gas source. The second chamber is disposed adjacent to the first chamber. The separator is disposed between the first and second chambers. The separator is adapted to communicate the inflation gas from the first chamber to the second chamber. The first chamber is disposed below the second chamber and the second chamber is inflated to a higher pressure than the first chamber when the side impact air bag is in the inflated condition.

The first chamber may be disposed proximate a thorax and below a shoulder of the seat occupant and the second chamber may be disposed proximate a pelvis and below the thorax of the seat occupant when the side impact air bag is in the inflated condition. The first chamber may be disposed proximate a shoulder and above a thorax of the seat occupant and the second chamber may be disposed proximate a head and above the shoulder of the seat occupant when the side impact air bag is in the inflated condition.

### BRIEF DESCRIPTION OF THE DRAWINGS

FIG. 1 is a fragmentary side view of a vehicle having an air bag in accordance with a first embodiment of the present invention.

FIG. 2 is a top view of the vehicle and air bag shown in FIG. 1.

FIG. 3 is a perspective view of the air bag shown in FIG. 1.

FIG. 4 is a side view of a second embodiment of the air bag.

FIG. 5 is a side view of a third embodiment of the air bag.

FIG. 6 is a side view of a fourth embodiment of the air bag.

FIG. 7 is a side view of a fifth embodiment of the air bag.

FIG. 8 is a side view of a sixth embodiment of the air bag.

### DETAILED DESCRIPTION OF THE PREFERRED EMBODIMENT(S)

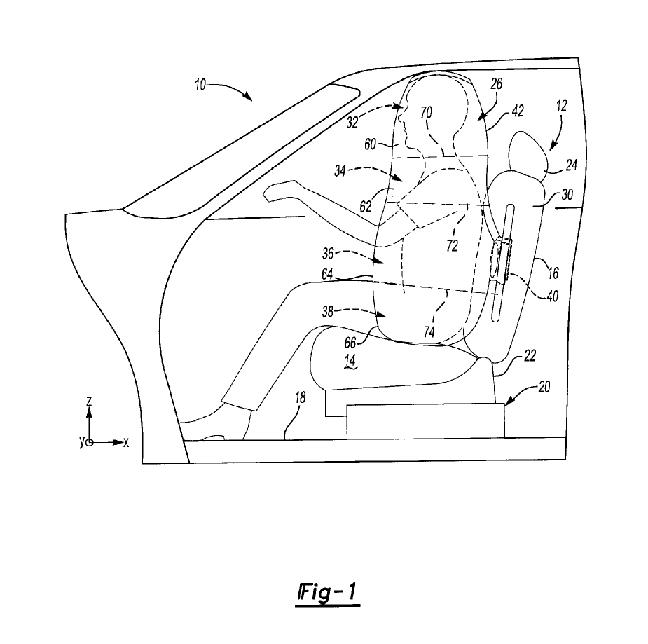

Referring to FIG. 1, a side view of a vehicle 10 is shown. The vehicle 10 includes a seat assembly 12 having a seat bottom 14 and a seat back 16.

The seat bottom 14 is attached to a vehicle floor 18 via seat adjuster mechanisms 20 that enable lateral and/or vertical movement of the seat bottom 14 with respect to the vehicle floor 18.

The seat bottom 14 and the seat back 16 are connected by pivot mechanisms 22 disposed on opposite sides of the seat assembly 12 that allow the seat back 16 to pivot with respect to the seat bottom 14.

The seat back 16 includes a headrest 24 adapted to support the head of a seat occupant 26 during a vehicle impact event. The seat back 16 may also include an air bag assembly 30.

The seat occupant 26 has head 32, shoulder 34, thorax 36, and pelvic 38 regions. The head or head region 32 is disposed above the shoulder 34. The thorax 36 includes a portion of the occupant 26 disposed below the shoulder 34 and above the pelvis or pelvic region 38. The pelvic region 38 includes a hip section disposed below the waist of the occupant 26 and above the seat bottom 14 when the occupant 26 is seated.

The air bag assembly 30 includes an inflation gas source or inflator 40 and an air bag 42.

The inflator 40 is adapted to provide an inflation gas to the air bag 42. The inflator 40 may be disposed in any suitable location, such as proximate the seat assembly 12 or under an interior trim surface. In the embodiment shown, the inflator 40 is attached to a frame of the seat back 16.

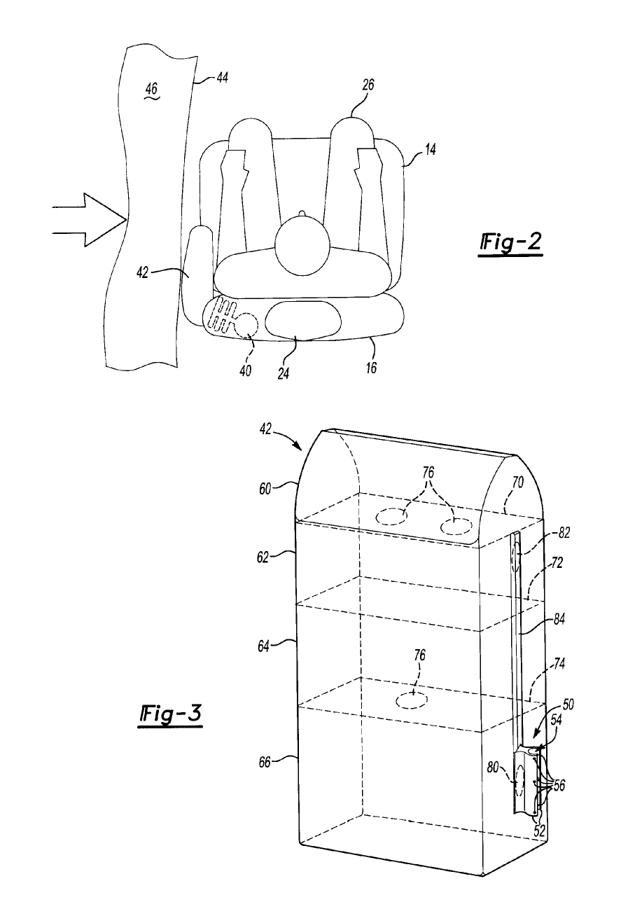

The air bag 42 is adapted to receive inflation gas from the inflator 40. The inflation gas causes the air bag 42 to expand from a stored condition to an inflated condition. More specifically, the air bag 42 is deflated and stored under an interior vehicle surface when it is in the stored condition and is inflated to be positioned between the seat occupant 26 and an interior vehicle surface when in the inflated condition. In the embodiment shown in FIGS. 1 and 2, the air bag 42 is configured to be stored under a surface of the seat back 16 and expand through a deployment opening 36 when inflated to separate the occupant 26 from a vehicle door 46. Alternatively, the air bag 42 may be stored under another interior vehicle surface, such as in seat bottom 14. The air bag is shown in the inflated condition in solid lines in FIGS. 1 and 2 and is shown in the stored condition in phantom in FIG. 2.

Multiple air bag embodiments are contemplated by the current invention as described in detail below. In each embodiment, the air bag may be made of any suitable material and may be assembled in any suitable manner, such as by stitching, bonding, or with an adhesive. In addition, each air bag embodiment is fluidly connected to the inflator 40 and includes a plurality of chambers stacked in a generally vertical configuration. Each chamber is separated from an adjacent chamber by a separator.

The separators are attached to opposing interior surfaces of the air bag to control the shape of the air bag upon deployment. The separators may be adapted to permit inflation gas to flow from one chamber to another to facilitate inflation. For example, the separators may be made of a gas permeable material that permits a limited amount of inflation gas to leak between adjacent chambers. Alternatively, the separators may include one or more apertures that facilitate the flow of gas between adjacent chambers. As noted below, a separator may also be configured to inhibit the flow of inflation gas between adjacent chambers.

Each air bag embodiment may be fluidly connected to the inflator 40 in any suitable manner. In the embodiment shown in FIG. 3, the air bag is coupled to the inflator 40 with an attachment feature 50. The attachment feature 50 includes a plurality of flaps 52 that define a pocket 54 that is adapted to receive the inflator 40. The flaps 52 are configured to wrap around the inflator 40 and include a plurality of apertures 56 that are adapted to fit over attachment studs extending from the inflator 40 or an adjacent surface to secure the air bag 42 to the inflator 40.

Each air bag embodiment also includes at least one inlet. The inlet is adapted to permit inflation gas to flow from the inflator 40 into the air bag. An inlet may be disposed proximate the attachment feature 50 and a chamber. In air bag embodiments that include a plurality of inlets, at least one inlet may be fluidly connected to the attachment feature 50 and/or inflator 40 by a diffuser or tube.

Referring to FIGS. 1, 2, and 3, a first embodiment of the air bag is shown. In this embodiment, the air bag 42 has four chambers. More specifically, the air bag 42 includes a first chamber 60, a second chamber 62, a third chamber 64, and a fourth chamber 66. The first chamber 60 is disposed proximate the head 32 of the occupant 26 when inflated. The second chamber 62 is disposed adjacent to and below the first chamber 60 and proximate the shoulder 34 of the occupant 26 when inflated. The third chamber 64 is disposed adjacent to and below the second chamber 62 and proximate the thorax 36 of the occupant 26 when inflated. The fourth chamber 66 is disposed adjacent to and below the third chamber 64 and proximate the pelvis 38 of the occupant 26 when inflated.

The first chamber 60 is separated from the second chamber 62 by a first separator 70. The second chamber 62 is separated from the third chamber 64 by a second separator 72. The third chamber 64 is separated from the fourth chamber 66 by a third separator 74.

The first separator 70 is adapted to permit inflation gas to flow from the second chamber 62 to the first chamber 60. The third separator 74 is adapted to permit inflation gas to flow from the third chamber 64 to the fourth chamber 66. The second separator 72 may be adapted to inhibit the flow of inflation gas between the second and third chambers 62,64 or may be adapted to permit inflation gas to flow between the second and third chambers 62,64.

In the embodiment shown in FIG. 3, the first and third separators 70,74 include one or more apertures 76. The quantity and/or size of the apertures 76 may be configured to control the flow of inflation gas. For example, in the embodiment shown in FIG. 3, the third separator 74 has fewer apertures than the first separator 70 and provides greater restriction of the flow of inflation gas than the first separator 70.

The flow restriction qualities of the separators 70,72,74 allow the chambers 60,62,64,66 to be inflated to different pressures shortly after the release of inflation gas. Within approximately 20 milliseconds after inflation gas is released, the first chamber may have a pressure of 5-15 psi, the second chamber may have a pressure of 15-25 psi, the third chamber may have a pressure of 5-10 psi, and the fourth chamber may have a pressure of 30-45 psi.

The air bag 42 includes a lower or first inlet 80 and an upper or second inlet 82. The first inlet 80 permits inflation gas to flow into the fourth chamber 66. The second inlet 82 permits inflation gas to flow into the second chamber 62. In the embodiment shown, the second inlet 82 is coupled to the attachment feature 50 by a tube 84. The tube 84 may be provided on an interior or exterior surface of the air bag 42.

The chambers 60,62,64,64 may reach a fully inflated condition in a predetermined sequence to provide improved separation between a region of the occupant 26 and the interior vehicle surface 44. In the embodiment shown in FIGS. 1-3, the second chamber 62 and fourth chamber 66 are inflated before the first and third chambers 60,64. The first chamber 60 may be inflated before the third chamber 64 due to the greater flow restriction provided by the third separator 74 as compared to the first separator 70.

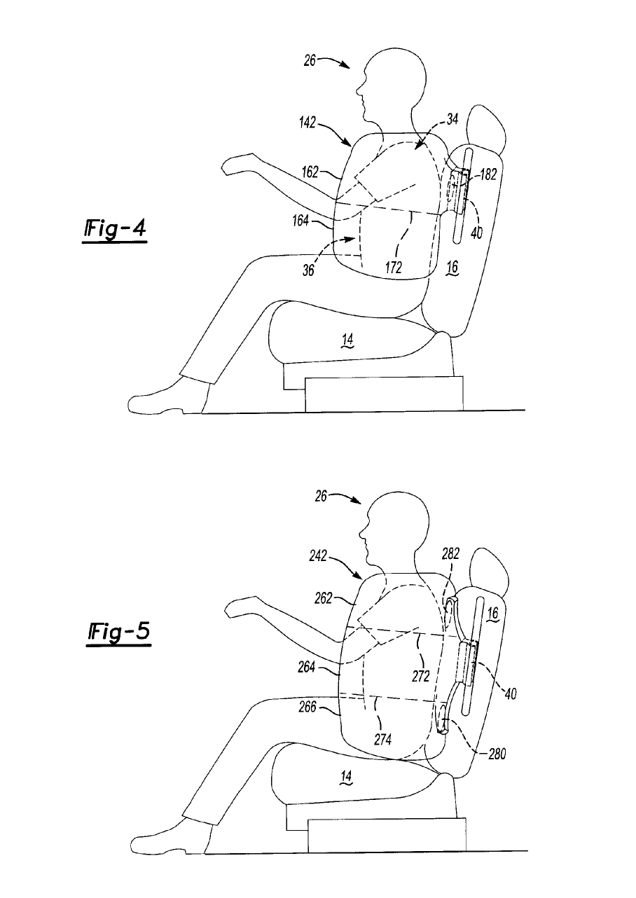

Referring to FIG. 4, an second embodiment of the air bag is shown. In this embodiment, the air bag 142 has two chambers and is adapted to protect the shoulder 34 and thorax 36 of the occupant 26. The upper or first chamber 162 is disposed proximate the shoulder 34 of the occupant 26 when in the inflated condition. The lower or second chamber 164 is disposed proximate the thorax 36 of the occupant 26 when in the inflated condition. The first and second chambers 162,164 are separated by a separator 172.

The first chamber 162 has an inlet 182 for receiving inflation gas in the manner previously described. The first chamber 162 is inflated before the second chamber 164. In addition, the first chamber 162 is inflated to a greater pressure than the second chamber 164 to reduce the likelihood of injury to the thorax region 36. More specifically, the inflation pressures may be within the ranges previously described with respect to the second and third chambers 62,64 of the first embodiment.

Referring to FIG. 5, a third embodiment of the air bag is shown. In this embodiment, the air bag 242 includes three chambers and is adapted to protect the shoulder 34, thorax 36, and pelvic 38 regions of the occupant 26. The first chamber 262 is disposed proximate the shoulder 34 of the occupant 26 when in the inflated condition. The second chamber 264 is disposed proximate the thorax 36 of the occupant 26 when in the inflated condition. The third chamber 266 is disposed proximate the pelvis 38 of the occupant 26 when in the inflated condition.

The first and second chambers 262,264 are separated by a first separator 272. The second and third chambers 264,266 are separated by a second separator 274. The first and/or second separators 272,274 permit inflation gas to flow to the second chamber 264.

The third and first chambers 266,262 have first and second inlets 280,282, respectively, for receiving inflation gas in the manner previously described. The first and third chambers 262,266 are inflated before the second chamber 264. In addition, the first and third chambers 262,266 are inflated to a greater pressure than the second chamber 264 to reduce the likelihood of injury to the thorax region 36. The inflation pressures may be within the ranges previously described with respect to the second, third, and fourth chambers 62,64,66 of the first embodiment.

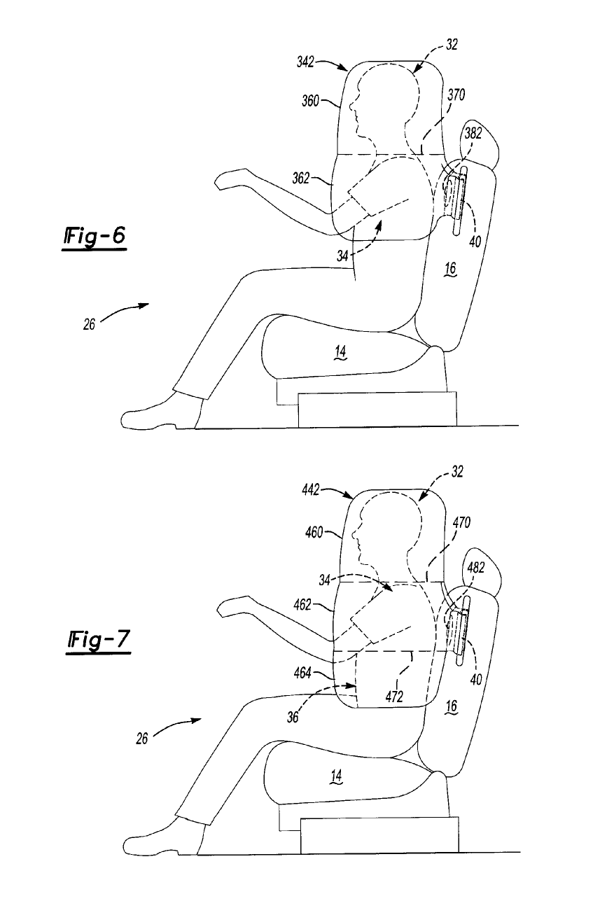

Referring to FIG. 6, a fourth embodiment of the air bag is shown. In this embodiment, the air bag 342 has two chambers and is adapted to protect the head 32 and shoulder 34 regions of the occupant 26. The upper or first chamber 360 is disposed proximate the shoulder 34 of the occupant 26 when in the inflated condition. The lower or second chamber 362 is disposed proximate the shoulder 34 of the occupant 26 when in the inflated condition. The first and second chambers 360,362 are separated by a separator 370.

The second chamber 360 has an inlet 382 for receiving inflation gas in the manner previously described. The second chamber 362 is inflated before the first chamber 360. In addition, the second chamber 362 is inflated to a greater pressure than the first chamber 360 to reduce the likelihood of injury to the head region 32. The inflation pressures may be within the ranges previously described with respect to the first and second chambers 60,62 of the first embodiment.

Referring to FIG. 7, a fifth embodiment of the air bag is shown. In this embodiment, the air bag 442 includes three chambers and is adapted to protect the head, 32, shoulder 34, and thorax 36 regions of the occupant 26. The first chamber 460 is disposed proximate the head 32 of the occupant 26 when in the inflated condition. The second chamber 462 is disposed proximate the shoulder 34 of the occupant 26 when in the inflated condition. The third chamber 464 is disposed proximate the thorax 36 of the occupant 26 when in the inflated condition.

The first and second chambers 460,462 are separated by a first separator 470. The second and third chambers 462,464 are separated by a second separator 472. The first and second separators 470,472 permit inflation gas to flow to from the second chamber 462 to the first and third chambers 460,464, respectively.

The second chamber 462 has an inlet 482 for receiving inflation gas in the manner previously described. The second chamber 462 is inflated before first and third chambers 460,464 and the first chamber 460 is inflated before the third chamber 464. In addition, the second chamber 462 is inflated to a greater pressure than the first and third chambers 460,464 to reduce the likelihood of injury to the head and thorax regions 32,36. The inflation pressures may be within the ranges previously described with respect to the first, second, and third chambers 60,62,64 of the first embodiment.

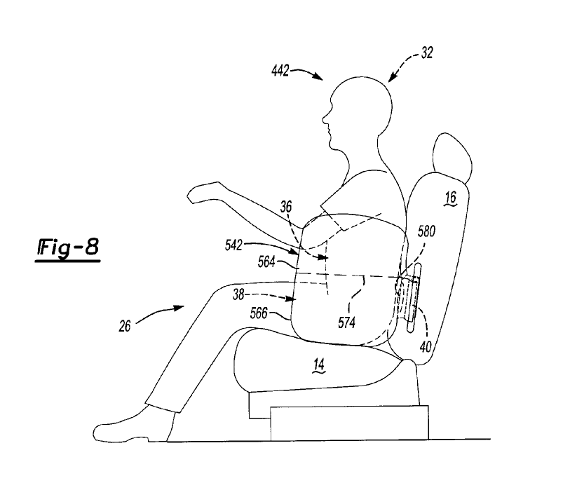

Referring to FIG. 8, a sixth embodiment of the air bag is shown. In this embodiment, the air bag 542 has two chambers and is adapted to protect the thorax 36 and pelvis 38 of the occupant 26. The upper or first chamber 564 is disposed proximate the thorax 36 of the occupant 26 when in the inflated condition. The lower or second chamber 566 is disposed proximate the pelvis 38 of the occupant 26 when in the inflated condition. The first and second chambers 564,566 are separated by a separator 574.

The second chamber 566 has an inlet 580 for receiving inflation gas in the manner previously described. The second chamber 566 is inflated before the first chamber 564. In addition, the second chamber 566 is inflated to a greater pressure than the first chamber 564 to reduce the likelihood of injury to the thorax region 32. The inflation pressures may be within the ranges previously described with respect to the third and fourth chambers 64,66 of the first embodiment.

The air bag embodiments of the present invention provide improved occupant protection compared to previous air bags that cushioned combinations of head, shoulder, thorax, and/or pelvic regions of a seat occupant with a single chamber. Moreover the air bag embodiments of the present invention permit chambers associated with the head, shoulder, thorax, and/or pelvic regions to be inflated to different pressures that are better suited for the expected impact forces and physical characteristics of the particular body region being protected. Furthermore, the air bag embodiments of the present invention permit chambers to be inflated in various predetermined sequences to provide improved separation from interior vehicle surfaces. For example, a chamber disposed proximate the shoulder region may be inflated before chambers associated with the head and/or thorax since the shoulder is disposed closer to an interior vehicle surface, such as a door panel, and is more likely to be contacted by the interior vehicle surface before the head or thorax during a side impact event. Similarly, a chamber associated with the pelvic region may be inflated before chambers associated with the head and/or thorax region due to the proximity of the pelvis to interior vehicle surfaces.

While the best mode for carrying out the invention has been described in detail, those familiar with the art to which this invention relates will recognize various alternative designs and embodiments for practicing the invention as defined by the following claims.

What is claimed is:

1. A side impact air bag for a motor vehicle, the side impact air bag having a stored condition in which the side impact air bag is located within a vehicle seat and an inflated condition in which the side impact air bag is located between a seat occupant and an interior vehicle surface, the side impact air bag comprising:
a first chamber having an inlet for receiving an inflation gas from an inflation gas source;
a second chamber disposed adjacent to the first chamber; and
a first separator disposed between the first and second chambers, the first separator adapted to communicate the inflation gas from the first chamber to the second chamber;
wherein the first chamber is disposed proximate a shoulder of the seat occupant and the second chamber is disposed proximate a thorax of the seat occupant when the side impact air bag is in the inflated condition.

2. The side impact air bag of claim 1 wherein the first chamber has a higher pressure than the second chamber within 20 milliseconds after the inflation gas is provided to inflate the side impact air bag.

3. The side impact air bag of claim 1 wherein the first separator includes at least one aperture adapted to communicate the inflation gas from the first chamber to the second chamber.

4. The side impact air bag of claim 1 wherein the first separator is a gas permeable membrane adapted to communicate the inflation gas from the first chamber to the second chamber.

5. The side impact air bag of claim 1 further comprising a third chamber disposed adjacent to the first chamber and a second separator disposed opposite the first separator and between the first and third chambers, the second separator being adapted to communicate the inflation gas from the first chamber to the third chamber, and wherein the third chamber is disposed proximate a head of the seat occupant when the side impact air bag is in the inflated condition.

6. The side impact air bag of claim 5 wherein the first chamber has a higher pressure than the third chamber and the third chamber has a higher pressure than the second chamber within 20 milliseconds after the inflation gas is provided to inflate the side impact air bag.

7. The side impact air bag of claim 5 wherein the first separator restricts the flow of inflation gas from the first chamber to the second chamber more than the second separator restricts the flow of inflation gas from the first chamber to the third chamber.

8. A side impact air bag for a motor vehicle, the side impact air bag having a stored condition in which the side impact air bag is located within a vehicle seat and an inflated condition in which the side impact air bag is located between a seat occupant and an interior vehicle surface, the side impact air bag comprising:
a first chamber having a first inlet for receiving an inflation gas from an inflation gas source;
a second chamber disposed adjacent to the first chamber;
a third chamber disposed adjacent to the second chamber and opposite the first chamber, the third chamber having a second inlet for receiving the inflation gas from the inflation gas source;
a first separator disposed between the first and second chambers; and
a second separator disposed between the second and third chambers;
wherein the first chamber is disposed proximate a shoulder of the seat occupant, the second chamber is disposed proximate a thorax of the seat occupant, and the third chamber is disposed proximate a pelvis of the seat occupant when the side impact air bag is in the inflated condition.

9. The side impact air bag of claim 8 wherein the first separator is adapted to communicate the inflation gas from the first chamber to the second chamber.

10. The side impact air bag of claim 8 wherein the second separator is adapted to communicate the inflation gas from the third chamber to the second chamber.

11. The side impact air bag of claim 8 wherein the first separator is adapted to communicate the inflation gas from the first chamber to the second chamber and the second separator is adapted to communicate the inflation gas from the third chamber to the second chamber.

12. The side impact air bag of claim 8 wherein the third chamber has a higher pressure than the first chamber and the first chamber has a higher pressure than the second chamber within 20 milliseconds after the inflation gas is provided to inflate the side impact air bag.

13. The side impact air bag of claim 8 further comprising a fourth chamber disposed adjacent to the first chamber and opposite the second chamber, and a third separator disposed between the first and fourth chambers and opposite the first separator, wherein the fourth chamber is disposed proximate a head of the seat occupant when the side impact air bag is in the inflated condition.

14. The side impact air bag of claim 13 wherein the first separator is adapted to communicate the inflation gas from the first chamber to the second chamber, the second separator is adapted to communicate the inflation gas from the third chamber to the second chamber, and the third separator is adapted to communicate the inflation gas from the first chamber to the fourth chamber.

15. The side impact air bag of claim 13 wherein the first chamber has a higher pressure than the fourth chamber and the third chamber has a higher pressure than the second chamber within 20 milliseconds after the inflation gas is provided to inflate the side impact air bag.

16. The side impact air bag of claim 13 wherein the third separator restricts the flow of inflation gas from the first chamber to the fourth chamber more than the second separator restricts the flow of inflation gas from the third chamber to the second chamber.

17. The side impact air bag of claim 13 wherein the first and third chambers are inflated before the second and fourth chambers.

18. A side impact air bag for a motor vehicle, the side impact air bag having a stored condition in which the side impact air bag is located within a vehicle seat and an inflated condition in which the side impact air bag is located between a seat occupant and an interior surface of a vehicle door, the side impact air bag comprising:
a first chamber having an inlet for receiving an inflation gas from an inflation gas source;
a second chamber disposed adjacent to the first chamber; and
a separator disposed between the first and second chambers, the separator being adapted to communicate the inflation gas from the first chamber to the second chamber;
wherein the first chamber is disposed below the second chamber and the second chamber is inflated to a higher pressure than the first chamber when the side impact air bag is in the inflated condition.

19. The side impact air bag of claim 18 wherein the first chamber is disposed proximate a thorax and below a shoulder of the seat occupant and the second chamber is disposed proximate a pelvis and below the thorax of the seat occupant when the side impact air bag is in the inflated condition.

20. The side impact air bag of claim 17 wherein the first chamber is disposed proximate a shoulder and above a thorax of the seat occupant and the second chamber is disposed proximate a head and above the shoulder of the seat occupant when the side impact air bag is in the inflated condition.
